(19) United States
(12) Patent Application Publication
(10) Pub. No.: US 2006/0194028 A1
(43) Pub. Date: Aug. 31, 2006

(54) Replacement skins for a writing surface

(75) Inventor: Greg Moore, Morgans Point, TX (US)

Correspondence Address: NATH & ASSOCIATES, 112 South West Street, Alexandria, VA, 22314, US

(73) Assignee: BEST-RITE CHALKBOARD COMPANY

(21) Appl. No.: 11/116,208

(22) Filed: Apr. 28, 2005

Related U.S. Application Data
(63) Continuation-in-part of application No. 11/065,042, filed on Feb. 25, 2005, now abandoned.

(51) Int. Cl. B41M 5/00

(52) U.S. Cl. 428/195.1

(57) ABSTRACT

The present inventive subject matter relates to a replacement skin for a writing surface comprising a top writable and erasable layer, a middle structure layer, and a connective layer, wherein the top writable and erasable layer, the middle structure layer, and the connective layer are all integrally connected to form a layered sheet. The present inventive subject matter further relates to a device and methodology for refurbishing old dry erase boards, without having to replace the entire board. Moreover, the present inventive subject matter relates to a device and methodology for refurbishing old blackboards, without having to replace the entire board. Additionally, the present inventive subject matter relates to a device and methodology for converting a blackboard into a dry erase board, as well as a more efficient and cost effective way of refurbishing old dry erase boards and chalkboards.

### FIELD OF THE INVENTION

The present inventive subject matter relates to replacement skins for writing surfaces. More particularly, the present inventive subject matter relates to replacement skins for writing surfaces in which the replacement skins have a writable and erasable top layer, a middle structure layer, and a connective layer all integrally connected to form a layered sheet. Additionally, the present inventive subject matter relates to replacement skins for writing surfaces in which the replacement skins have a writable and erasable top layer, a middle structure layer, a core layer, and a connective layer all integrally connected to form a layered sheet.

### BACKGROUND OF THE INVENTION

In learning and work environments, such as schools and businesses, the ability to accurately and efficiently display, convey, and record information temporarily or permanently has been critical in the progression of knowledge and business. Many devices and systems have been conjured up over the years to aid this progression, from straight-forward mechanical devices, to complex electronic devices.

One of the simplest mechanical devices utilized for displaying, conveying, and recording information is the use of paper and a writing utensil, such as a pad of paper and pencil. However, in many instances this form of information displaying, conveying, and recording is impractical. For example, if one wants to convey information to another person or a group of people, the use of a pad of paper and writing utensil is not only a arduous task, but extremely time consuming, and can be very counter productive. This is especially true when one wants to convey information to a large group of people. In addition, pads of paper are relatively fragile and can deteriorate over time and with continued use, and are limited by the number of paper pages in the pad. Once the pad runs out of usable paper pages, the pad of paper is no longer useful. For this very reason, display devices have been invented to help ease the task of displaying, conveying, and recording information to another person or a group of people.

In particular, chalk boards and dry erase boards, also known as white boards and marker boards, have been invented and are well known in the art as display devices for displaying, conveying, and recording information. These boards typically have a writing surface and a frame surrounding the peripheral edge of the board. Other optional features include a tray to house chalk and/or markers, and a metal backing behind the writing surface to enable the writing surface to become magnetically attractable.

Chalk boards, such as blackboards are still very popular as display devices, especially in learning environments such as schools and universities. However, due to the mess and hassle associated with chalk, many schools and universities are converting from using chalk boards to using dry erase boards. In addition to the mess and hassle associated with chalk, after continued use over a period of time, chalk boards begin to loose their luster and begin to chip and crack. Due to these problems, many institutions are replacing chalk boards with less messy, easy to use dry erase boards.

Dry erase boards reduce the mess and hassle associated with chalk boards, however even they begin to loose their luster after continued use over a period of time. Ghosting, in which the ink used in the dry erase markers permeates into the board, occurs after continued use and when information is stored on the surface of the board for extended periods of time. Additionally, even dry erase boards can experience cracking and chipping after extended use and from environmental conditions.

However, dry erase boards and blackboards are expensive overhead for institutions to replace. In many instances the frame, tray, core layer, and securing device(s) of the chalk board or dry erase board are still in reasonably good shape when the writing surface starts to fail and become in undesirable shape. Just one dry erase board or black board can cost several hundred dollars depending on the size and attributes of the board. In particular, boards with solid metal frames and trays, or wooden finished frames, can be quite costly to replace. Due to the reasonable shape of the rest of the board, many times institutions do not replace the failing board since many times institutions see it as wasteful to discard an entire board just because the writing surface is in less desirable or bad shape.

Consideration also is given to the cost and time associated with the removing and disposing of the old board, and buying and installing a new board. Even more so, with institution budget restraints, many times old, worn out, failing chalkboards and dry erase boards are not replaced until years after they ideally should be.

### SUMMARY OF THE INVENTION

Therefore, it would be advantageous to have a device and methodology for refurbishing old dry erase boards, without having to replace the entire board. Further, it would be advantageous to have a device and methodology for refurbishing old blackboards, without having to replace the entire board. Additionally, it would also be advantageous to have a device and methodology for converting a blackboard into a dry erase board. Even more advantageous would a more efficient and cost effective way of refurbishing old dry erase boards and chalkboards.

The present inventive subject matter relates to a replacement skin for a writing surface comprising a top writable and erasable layer, a middle structure layer connected to the top writable and erasable layer, and a connective layer connected to the middle structure layer, wherein the top writable and erasable layer, the middle structure layer, and the connective layer form a layered sheet.

Additionally, the present inventive subject matter relates to a method of manufacturing a replacement skin for a writing surface comprising fusing a top writable and erasable layer to a middle structure layer and adhering a connective layer to said middle structure layer, wherein the top writable and erasable layer, the middle structure layer, and the connective layer are integrally connected to form a layered sheet.

The present inventive subject matter further relates to a replacement skin comprising a peel-off protective back cover. Further, the present inventive subject matter relates to a replacement skin, wherein said peel-off protective back cover comprises a polymeric material. Moreover, the present inventive subject matter relates to a replacement skin, wherein the polymeric material is selected from at least one of the group consisting of crystalline polymer, amorphous polymer, semi-crystalline polymer, thermoset polymer, thermoplastic polymer, elastomer polymer, and combinations thereof.

The present inventive subject matter additionally relates to a replacement skin, wherein the peel-off protective back cover comprises at least one polymer selected from the group consisting of polypropylene, polyethylene, polyurethane, polybutylene, polysulfone, polyethersulfone, high-molecular-weight polyethersulfone, polyphenylsulfone, polyvinylidene, fluoride polyamide-imide, PVDF homopolymer, PVDF copolymer, PVDF homopolymer, ECTFE copolymer, ECTFE nBuA terpolymer, polyarylamide, liquid crystal polymer, acrylonitrile-butadiene-styrene, allyl resin, aramid, bakelit, diene polymer, dimethylformamid, epoxy, polyvinyl chloride, hydroxy-terminated polybutadiene (HTPB), teflon, nylon 6, nylon 6,6, polycarbonate, polyester, silicones, nylon, PA (Polyamid), PE (Polyethylen), phenol-formaldehyde, polyacrylates, polyacrylonitrile, polybutadiene, polyetherimide, polygermane, polystannane, polyimide, polyisoprene, polymethyl methacrylate, polyoxymethylene, polyoxymethylene copolymer, polyoxymethylene homopolymer, poly(para-xylylene), poly(phenylene oxide), poly(phenylenesulfide), polyphosphazenes, polypropylen, polysilanes, polystyrene, polystyrol, polytetrafluoroethylen, polyurethan, synthetic polyisoprene, and vinyl.

The present inventive subject matter further relates to a replacement skin, further comprising a core layer. Additionally, the present inventive subject matter relates to a replacement skin, wherein said core layer comprises at least one element selected from the group consisting of metal, alloy, elastomer, polymer, wood, and combinations thereof. Moreover, the present inventive subject matter relates to a replacement skin, wherein said core layer is selected from the group consisting of fiberboard, particleboard, corkboard, steel, and combinations thereof.

The present inventive subject matter relates to a replacement skin, wherein the top writable and erasable layer comprises at least one element selected from the group consisting of glass, porcelain, slate, rubber, melamine, iron, and steel. The present inventive subject matter further relates to a replacement skin, wherein the top writable and erasable layer comprises at least one polymer.

The present inventive subject matter additionally relates to a replacement skin, wherein the middle structure layer comprises at least one element selected from the group consisting of metal, alloy, elastomer, polymer, wood, and combinations thereof. Additionally, the present inventive subject matter relates to a replacement skin, wherein the middle structure layer comprises at least one element selected from the group consisting of glass, porcelain, slate, rubber, melamine, iron, and steel.

Moreover, the present inventive subject matter relates to a replacement skin, wherein the connective layer comprises at least one adhesive selected from the group consisting of adhesive dispersion, solids adhesive, solvent-borne adhesive, heat-activated adhesive, reactive adhesive, contact adhesive, hot-melt adhesive, spray adhesive, liquid adhesive, emulsion adhesive, rubber containing adhesive, acrylic containing adhesive, modified acrylic containing adhesive, polyurethane containing adhesive, polyvinyl acetate containing adhesive, polychloroprene containing adhesive, isocyanate containing adhesive, polyisocyanate containing adhesive, polyol containing adhesive, butyl rubber containing adhesive, ethylene vinyl acetate containing adhesive, silicone containing adhesive, organosiloxane containing adhesive, methacrylic containing adhesive, epoxy containing adhesive, rubber containing adhesive, and cyanoacrylate containing adhesive.

The present inventive subject matter further, relates to a method of manufacturing a replacement skin for a writing surface further comprising adhering a core layer to the middle structure layer. Additionally, the present inventive subject matter relates to a method of manufacturing a replacement skin for a writing surface further comprising attaching a peel-off protective back cover to the connective layer.

The present inventive subject matter also relates to a method of refurbishing a writing surface comprising cleaning an old writing surface of a writing board, applying alcohol to the old writing surface of the writing board, removing a peel-off protective back cover from the replacement skin, attaching the replacement skin to the old writing surface, and applying pressure to the replacement skin to adhere the connective layer of the replacement skin to the old writing surface. Further, the present inventive subject matter relates to a method of refurbishing a writing surface wherein the alcohol is in a solution comprising water.

### BRIEF DESCRIPTION OF THE FIGURES

FIG. 1 is an illustration of a sectional side view along line 1 of an embodiment of a replacement skin for a writing surface;

FIG. 2 is another illustration of a sectional side view along line 1 of another embodiment of a replacement skin for a writing surface;

FIG. 3 is another illustration of a sectional side view along line 1 of another embodiment of a replacement skin for a writing surface;

FIG. 4 is a front assembly view of an embodiment of a replacement skin for a writing surface being applied to an old surface;

FIG. 5 is another front assembly view of another embodiment of a replacement skin for a writing surface being applied to an old surface.

FIG. 6 is a flowchart for manufacturing an embodiment of a replacement skin for a writing surface.

FIG. 7 is another flowchart for manufacturing an embodiment of a replacement skin for a writing surface.

FIG. 8 is an illustration of a lamination process for manufacturing an embodiment of a replacement skin for a writing surface.

FIG. 9 is another illustration of a lamination process for manufacturing an embodiment of a replacement skin for a writing surface.

### DETAILED DESCRIPTION OF THE INVENTION

The present inventive subject matter relates to replacement skins for a writing surface comprising a top writable and erasable layer, a middle structure layer connected to the top writable and erasable layer, and a connective layer connected to the middle structure layer, wherein the top writable and erasable layer, the middle structure layer, and the connective layer form a layered sheet.

The present inventive subject matter further relates to a device and methodology for refurbishing old dry erase boards, without having to replace the entire board. Further, the present inventive subject matter relates to a device and methodology for refurbishing old blackboards, without having to replace the entire board. Additionally, the present inventive subject matter relates to a device and methodology for converting a blackboard into a dry erase board, as well as a more efficient and cost effective way of refurbishing old dry erase boards and chalkboards.

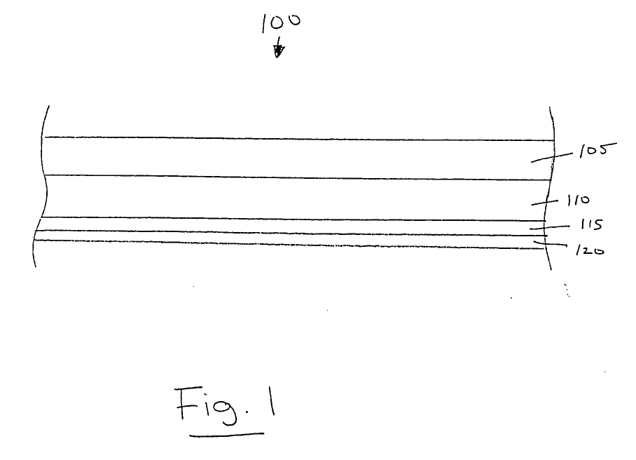

Referring now to FIG. 1, an embodiment of a replacement skin for a writing surface 100 is illustrated. A top writable and erasable layer 105 is connected to a middle structure layer 110, which is between the top writable and erasable layer 105 and connective layer 115. The opposite side of connective layer 115 is further connected to peel-off protective back cover 120. Top writable and erasable layer 105, middle structure layer 110, connective layer 115, and peel-off protective back cover 120 are all collectively layered in the above order and collectively form a layered sheet.

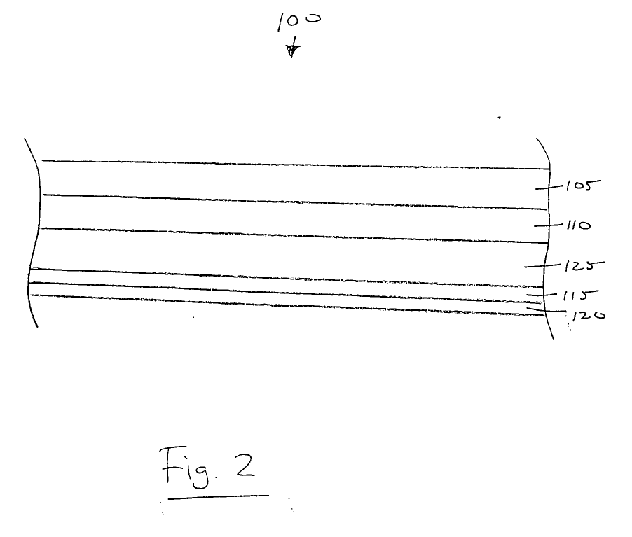

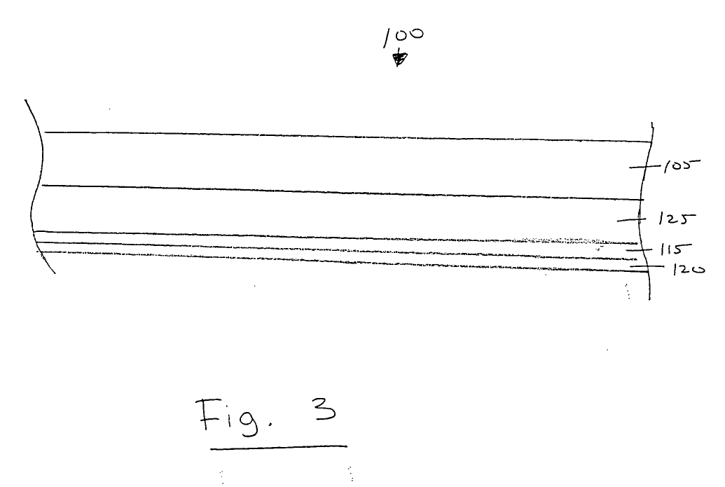

As shown in FIG. 2 and FIG. 3, a core layer 125 may also be incorporated into the replacement skin for a writing surface 100. Core layer 125 can be disposed between any of the layers, and as shown in FIGS. 2 and 3 for exemplary purposes only, core layer 125 is disposed between middle structure layer 110 and connective layer 115, and writable and erasable layer 105 and connective layer 115, respectively.

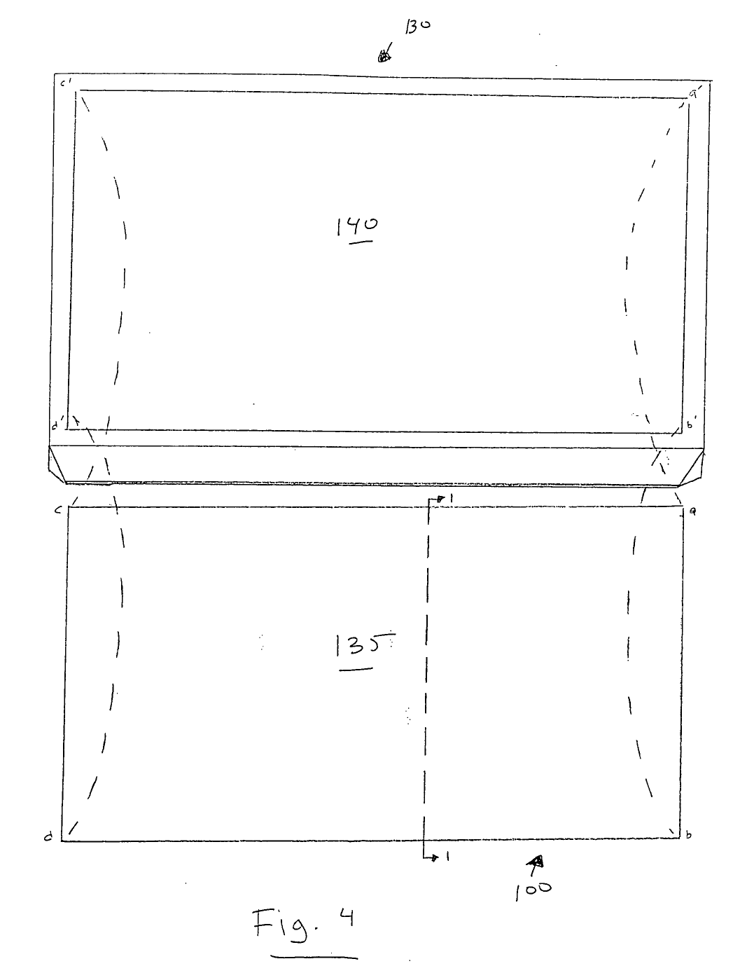

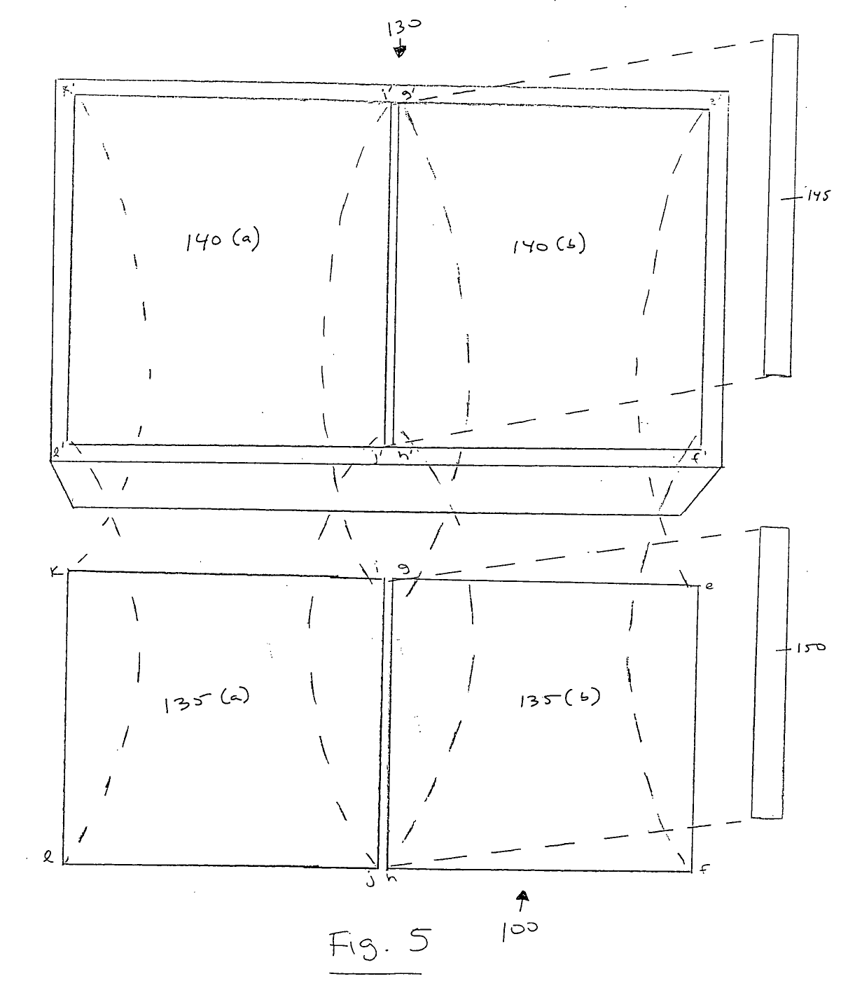

Referring now to FIGS. 4 and 5, assembly diagrams are illustrated. As shown in FIG. 4, an embodiment of a replacement skin for a writing surface 100 can be connected to a chalk board or dry erase board, generally referred to as board 130, by placing and connecting replacement skin 100 having new writing surface 135 over and to old writing surface 140 of board 130. Corners A-D of replacement skin 100 align with corners A′-D′ of board 130 when replacement skin 100 is placed over and to old writing surface 140.

Similarly, FIG. 5 illustrates an assembly diagram for an embodiment of a replacement skin 100 having new writing surfaces 135(a) and 135(b). Replacement skin 100 having new writing surfaces 135(a) and 135(b) are placed over and connect to old writing surfaces 140(a) and 140(b) of board 130. Board 130 has an h-bar 145 between old surfaces 140(a) and 140(b), which is replaced by cover bar 150 between new surfaces 135(a) and 135(b). Corners E-H of replacement skin 100 having new writing surface 135(b), align with corners E′-H′ of board 130 having old writing surface 140(b). Additionally, corners I-L of replacement skin 100 having new writing surface 135(a), align with corners I′-L′ of board 130 having old writing surface 140(a).

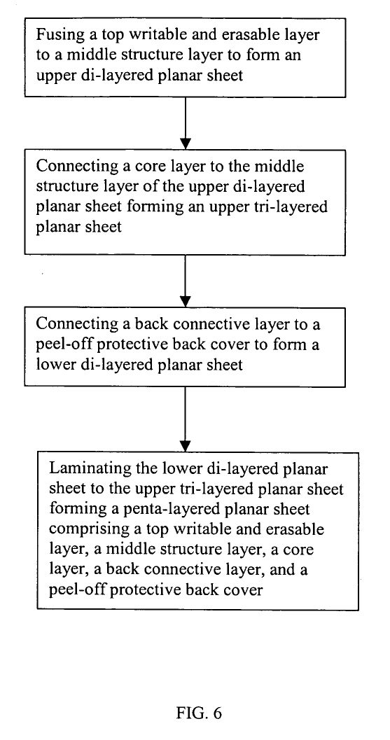

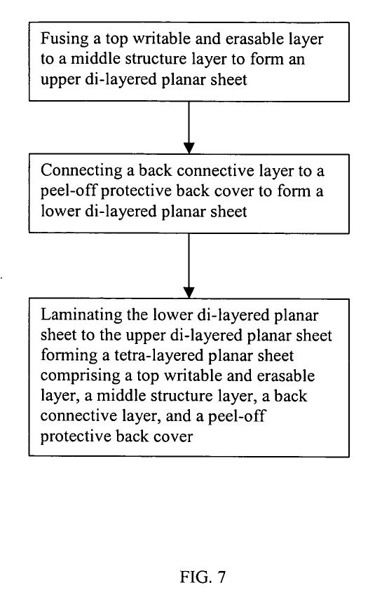

Referring now to FIGS. 6 and 7, manufacturing flowcharts are illustrated. As illustrated in FIG. 6, a process for manufacturing an embodiment of a replacement skin for a writing surface 100 as previously shown and described, comprises the steps of fusing a top writable and erasable layer 105 to a middle structure layer 110 to form an upper di-layered sheet 165, connecting a core layer 125 to the middle structure layer 110 of the upper di-layered sheet 165 forming an upper tri-layered sheet 155, connecting a connective layer 115 to a peel-off protective back cover 120 to form a lower di-layered sheet 160, and laminating the lower di-layered sheet 160 to the upper tri-layered sheet 155 forming a penta-layered sheet 175 comprising a top writable and erasable layer 105, a middle structure layer 110, a core layer 125, a connective layer 115, and a peel-off protective back cover 120.

Similarly, FIG. 7 illustrates another manufacturing flowchart for another embodiment of a replacement skin for a writing surface 100 as previously shown and described. The process as described in FIG. 7 comprises fusing a top writable and erasable layer 105 to a middle structure layer 110 to form an upper di-layered sheet 165, connecting a connective layer 115 to a peel-off protective back cover 120 to form a lower di-layered sheet 160, and laminating the lower di-layered sheet 160 to the upper di-layered sheet 165 forming a tetra-layered sheet 180 comprising a top writable and erasable layer 105, a middle structure layer 110, a connective layer 115, and a peel-off protective back cover 120.

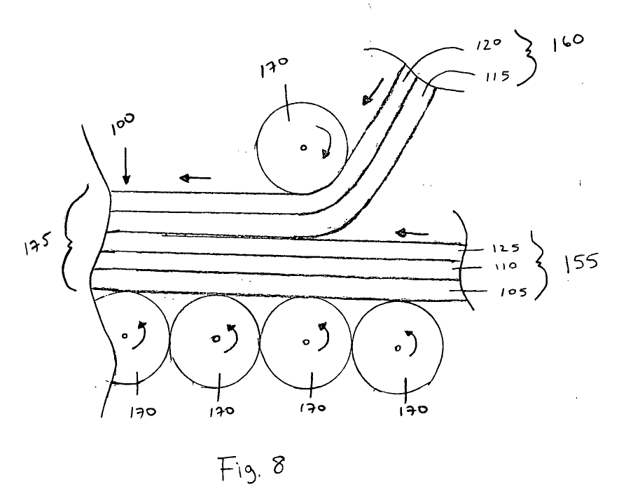

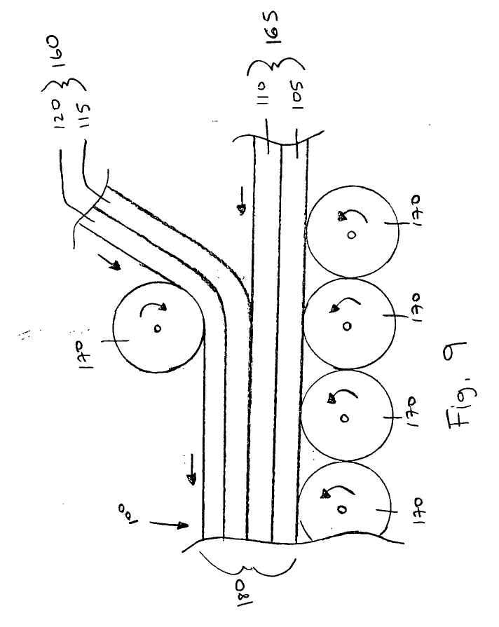

Referring now to FIGS. 8 and 9, lamination processes for manufacturing embodiments of a replacement skin for a writing surface 100 are illustrated. As illustrated in FIG. 8, an upper tri-layered sheet 155 comprising a top writable and erasable layer 105, a middle structure layer 110, and a core layer 125 is laminated to a lower di-layered sheet 160 comprising a connective layer 115 and a peel-off protective back cover 120 by a lamination apparatus comprising a series of rollers 170 to produce an embodiment of a replacement skin for a writing surface 100.

Similarly, FIG. 9 illustrates another lamination process for manufacturing an embodiment of a replacement skin for a writing surface 100. The process as illustrated is FIG. 9 comprises laminating an upper di-layered sheet 165 comprising a top writable and erasable layer 105 and a middle structure layer 110 to a lower di-layered sheet 160 comprising a connective layer 115 and a peel-off protective back cover 120. In both FIGS. 8 and 9, the rollers 170 of the lamination apparatus press fit the lower di-layered sheet 160 to the upper di-layered 165 or tri-layered sheet 155, respectively, such that the bond between the connective layer 115 of the lower di-layered sheet 160 and either the middle structure layer 110 or the core layer 125 of the upper di-layered sheet 165 or the upper tri-layered sheet 155 is greater than the bond between the connective layer 115 and the peel-off protective back cover 120 of the lower di layered sheet 160.

The above embodiments are merely exemplary embodiments of the present inventive subject matter, and should not be seen as limiting the scope of the disclosure provided herein.

The term “substantially” being used herein, generally refers to within about 75 to about 100 percent when referencing attributes of size. When referencing a type of bond or adhering strength, substantially generally refers to being connected thereto and remaining connected thereto under normal environmental and usage conditions.

Writable and erasable layer 105 can be constructed to perform as a dry erase board, chalk board, or similar writable and erasable surface. Further, the writable and erasable layer 105 can be of any suitable size, shape, and color, and can be constructed of any suitable material, including, but not limited to any metal, alloy, plastic, polymer, elastomer, wood, glass, rock, and combinations thereof. Non-limiting examples of metals and alloys include iron, steel, aluminum, tin, copper, bronze, and combinations and derivatives thereof. Non-limiting examples of polymers and elastomers include thermoplastic polymers, thermoset polymers, crystalline polymers, amorphous polymers, semi-crystalline polymers, elastomer polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations and derivatives thereof. Non-limiting examples of wood include compositions with cellulosic fiber including particleboard, fiberboard, plywood, and combinations and derivatives thereof. Non-limiting examples of glass include fiberglass, porcelain, tempered glass, and combinations and derivatives thereof. A non-limiting example of rock includes slate. In an embodiment, the writable and erasable layer 105 comprises porcelain. In another embodiment, writable and erasable layer 105 comprises a polymer, such as melamine. In yet another embodiment, writable and erasable layer 105 comprises slate. One purpose of the writable and erasable layer 105 is to serve as a surface for displaying, conveying, and/or recording information.

Writable and erasable layer 105 can be chemically or mechanically connected to middle structure layer 110, core layer 125, or connective layer 115 by chemical interactions or mechanical devices. Non-limiting examples of mechanical devices include at least one bolt, screw, nail, clamp, crimp, or similar device, and combinations thereof. Non-limiting examples of chemical interactions include at least one adhesive, bonding agent, or similar interaction, and combinations thereof. Additionally, writable and erasable layer 105 can be connected to middle structure layer 110, core layer 125, or connective layer 115 by at least one exothermic or endothermic lamination process, fusing process, coating process, or similar process.

Middle structure layer 110 can be of any suitable size, shape, and color, and can be constructed of any suitable material, including, but not limited to any metal, alloy, plastic, polymer, elastomer, wood, glass, and combinations thereof. In an embodiment, middle structure layer 110 comprises a metal, such as but not limited to steel. In another embodiment, middle structure layer 110 comprises a polymer material. Non-limiting examples of metals and alloys include iron, steel, aluminum, tin, copper, bronze, and combinations and derivatives thereof. Non-limiting examples of polymers and elastomers include thermoplastic polymers, thermoset polymers, crystalline polymers, amorphous polymers, semi-crystalline polymers, elastomer polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations and derivatives thereof. Non-limiting examples of wood include compositions with cellulosic fiber including particleboard, fiberboard, plywood, and combinations and derivatives thereof. Non-limiting examples of glass include fiberglass, porcelain, tempered glass, and combinations and derivatives thereof. In yet another embodiment, middle structure layer 110 is substantially the same size in two dimensions as top writable and erasable layer 105.

One purpose of the middle structure layer 110, when present, is to structurally support the writable and erasable layer 105. Another purpose of the middle structure layer 110, when present, is to provide an intermediate layer between the writable and erasable layer 105 and the core layer 125. An even further purpose of the middle structure layer 110, when present, is to provide a layer in which the writable and erasable layer 105 can be substantially connected thereto, and can be chemically and/or mechanically attached to core layer 125. In an embodiment of the present subject matter, the middle structure layer 110 is optional.

Core layer 125 can be of any suitable size, shape, and color, and can be constructed of any suitable material, including, but not limited to any metal, alloy, plastic, polymer, elastomer, wood, glass, and combinations thereof. In an embodiment, core layer 125 comprises a wood, such as but not limited to fiber board, particle board, plywood, or combinations thereof. In another embodiment, core layer 125 comprises a polymer material. Non-limiting examples of metals and alloys include iron, steel, aluminum, tin, copper, bronze, and combinations and derivatives thereof. Non-limiting examples of polymers and elastomers include thermoplastic polymers, thermoset polymers, crystalline polymers, amorphous polymers, semi-crystalline polymers, elastomer polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations and derivatives thereof. Non-limiting examples of wood include compositions with cellulosic fiber including particleboard, fiberboard, plywood, and combinations and derivatives thereof. Non-limiting examples of glass include fiberglass, porcelain, tempered glass, and combinations and derivatives thereof. In yet another embodiment, core layer 125 is substantially the same size in two dimensions as top writable and erasable layer 105. Additionally, in another embodiment, core layer 125 is substantially the same in two dimensions as middle structure layer 110. Moreover, in another embodiment, core layer is substantially the same in two dimensions as both top writable and erasable layer 105 and middle structure layer 110. One purpose of the core layer 125, when present, is to structurally support the writable and erasable layer 105 and middle structure layer 110. In an embodiment of the present subject matter, the core layer 125 is optional.

Core layer 125 can be connected to the writable and erasable layer 105 and/or middle structure layer 110 by any suitable mechanical device or chemical interaction. Non-limiting examples of mechanical devices include at least one bolt, screw, nail, clamp, crimp, or similar device, and combinations thereof. Non-limiting examples of chemical interactions include at least one adhesive, bonding agent, or similar interaction, and combinations thereof. Additionally, the core layer 125 can be connected to the writable and erasable layer 105 and/or middle structure layer 110 by at least one exothermic or endothermic lamination process, fusing process, or similar process.

Moreover, core layer 125 can be connected to connective layer 115 by any suitable mechanical or chemical interaction as described above. Core layer 125 can also be connected to connective layer 115 by at least one exothermic or endothermic lamination process, fusing process, coating process, or similar process.

Connective layer 115 can be any chemical composition, agent, mixture, emulsion, adhesive, or mechanical device, which connects the top writable and erasable layer 105 directly or indirectly to an old writing surface 140. In an embodiment, connective layer 115 can be constructed of any suitable material in addition to an adhesive, including, but not limited to any metal, alloy, plastic, polymer, elastomer, wood, glass, and combinations thereof. If the connective layer 115 comprises a chemical substance, the chemical substance can be present in a continuous, or non-continuous, porous, or non-porous layer. Further, if the connective layer 115 comprises a chemical substance, the chemical substance can be present in separate or joined, connected or unconnected lines, dots, or other patterns. In an embodiment, the connective layer 115 comprises at least one chemical composition, agent, mixture, emulsion, or adhesive, or at least one mechanical device. Additionally, the connective layer 115 can be located in part, or wholly, around the perimeter of the replacement skin 100.

One purpose of the connective layer 115 is to substantially connect the top writable and erasable layer 105 directly or indirectly to an old writing surface 140. Further, the connective layer 115 does not have to be medially located wholly or in part between a surface of the top writable and erasable layer 105 and the old writing surface 140. It is within the scope and breath of this disclosure for the connective layer 115 to include materials or entities located outside of the medial surface area of the top writable and erasable layer 105 and the old writing surface 140. As non-limiting examples, securing devices, separately or in combination, bolts, nails, staples, crimps, and clamps can be located along the outer portions of the replacement skin 100 substantially securing the top writable and erasable layer 105 and the old writing surface 140.

Preferably the connective layer 115 is constructed in part, or in whole, of at least one chemical composition, agent, mixture, emulsion, or adhesive. In some embodiments of the present inventive subject matter the chemical composition can be any suitable adhesive, including but not limited to, an acrylic adhesive. Further, the adhesive can contain at least one additional additive, including but not limited to, surfactant(s), dye(s), preservative(s), anti-oxidant(s), wetting agent(s), tackifier(s), and combinations and derivatives thereof. The adhesive can be, but is not limited to, at least one adhesive dispersion, solids adhesive, solvent-borne adhesive, heat-activated adhesive, reactive adhesive, contact adhesive, hot-melt adhesive, spray adhesive, liquid adhesive, emulsion adhesive, rubber containing adhesive, acrylic containing adhesive, modified acrylic containing adhesive, polyurethane containing adhesive, polyvinyl acetate containing adhesive, polychloroprene containing adhesive, isocyanate containing adhesive, polyisocyanate containing adhesive, polyol containing adhesive, butyl rubber containing adhesive, ethylene vinyl acetate containing adhesive, silicone containing adhesive, and combinations and derivatives thereof. In an embodiment the adhesive is an acrylic containing, organosiloxane containing, methacrylic containing, epoxy containing, rubber containing, or cyanoacrylate containing adhesive.

In another embodiment, the connective layer 115 comprises an adhesive, preferably an acrylic containing adhesive, in a substantially continuous layer directly or indirectly between the writable and erasable layer 105 and peel-off protective back cover 120.

Peel-off protective back cover 120 can be of any suitable size, shape, and color, and can be constructed of any suitable material, including, but not limited to any metal, alloy, plastic, polymer, elastomer, wood, glass, cellulose containing material, and combinations thereof. In an embodiment, peel-off protective back cover 120 comprises a polymeric material. Non-limiting examples of polymers and elastomers include thermoplastic polymers, thermoset polymers, crystalline polymers, amorphous polymers, semi-crystalline polymers, elastomer polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations and derivatives thereof.

Additional non-limiting examples of polymeric materials suitable for use in constructing the peel-off protective back cover 120 include paraffin wax, polypropylene, polyethylene, polyurethane, polybutylene, polysulfone, polyethersulfone, high-molecular-weight polyethersulfone, polyphenylsulfone, polyvinylidene, fluoride polyamide-imide, PVDF homopolymer, PVDF copolymer, PVDF homopolymer, ECTFE copolymer, ECTFE nBuA terpolymer, polyarylamide, liquid crystal polymer, acrylonitrile-butadiene-styrene, allyl resin, aramid, bakelit, diene polymer, dimethylformamid, epoxy, polyvinyl chloride, hydroxy-terminated polybutadiene (HTPB), teflon, nylon 6, nylon 6,6, polycarbonate, polyester, silicones, nylon, PA (Polyamid), PE (Polyethylen), phenol-formaldehyde, polyacrylates, polyacrylonitrile, polybutadiene, polyetherimide, polygermane, polystannane, polyimide, polyisoprene, polymethyl methacrylate, polyoxymethylene, polyoxymethylene copolymer, polyoxymethylene homopolymer, poly(para-xylylene), poly(phenylene oxide), poly(phenylenesulfide), polyphosphazenes, polypropylen, polysilanes, polystyrene, polystyrol, polytetrafluoroethylen, polyurethan, synthetic polyisoprene, vinyl, and combinations and derivatives thereof.

Non-limiting examples of cellulose containing materials suitable for use in constructing the peel-off protective back cover include paper, wax paper, asphalt paper, kraft liner, abrasive kraft, absorbent kraft, wet strength paper, parchment paper, gray chip, schrenz, testliner, volatile corrosion inhibitor paper, alkaline paper, anti-rust paper, antique paper, azurelaid paper, base paper, and combinations thereof.

One purpose of the peel-off protective back cover 120 is to substantially prevent premature binding of replacement skin 100 to old writing surface 140. Additionally, another purpose of the peel-off protective back cover 120 is to prevent from having to place a chemical composition, agent, mixture, emulsion, adhesive, or combination thereof directly on an old writing surface 140 or replacement skin 100, before connecting the replacement skin 100 to the old writing surface 140. Another purpose of the peel-off protective back cover 120 is to protect the integrity of connective layer 115.

Additionally, the replacement skin 100 can comprise a peel-off protective front cover connected to writable and erasable layer 105 to protect the integrity and surface of writable and erasable layer 105 during manufacturing, shipping, and/or installation of the replacement skin 100. Peel-off protective front cover can be of any suitable size, shape, and color, and can be constructed of any suitable material, including, but not limited to any metal, alloy, plastic, polymer, elastomer, wood, glass, and combinations thereof. In an embodiment, peel-off protective front cover comprises a polymeric material. Non-limiting examples of polymers and elastomers include thermoplastic polymers, thermoset polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations and derivatives thereof.

Additionally, embodiments of replacement skins for a writing surface can be flexible or inflexible.

In an embodiment of a replacement skin for a writing surface 100, an upper di-layered sheet 165 comprising a writable and erasable layer 105 connected to a middle structure layer 110 can be produced by a fusing or coating process. Non-limiting examples of fusing or coating processes include, but are not limited to, vitreous enameling and powder coating processes. As a non-limiting example, vitreous enameling can be used to fuse a writable and erasable layer 105 comprising glass and/or porcelain to a steel middle structure layer 110 such that a substantial bond is formed between the writable and erasable layer 105 and middle structure layer 110. The vitreous enameling process can be accomplished, for example, by first using of a degreaser bath or detergents to clean the steel middle structure layer 110 of all surface impurities. Next, the steel middle structure layer 110 can be placed in an acid bath to etch the surface to promote the fusing process of the glass and/or porcelain writable and erasable layer 105. After the steel middle structure layer 110 has been placed in the acid bath to etch the surface, the steel middle structure layer 110 is then removed from the acid bath, and is rinsed and neutralized. A ground coat of glass and/or porcelain particles, also known as frit, is then applied to the steel middle structure layer 110, and is fired between about 600 and about 900° C. The ground coat can comprise one coating layer of flit, or several coating layers of frit. Oxides can also be added with the glass and/or porcelain particles to add color. The ground coat of glass and/or porcelain when fired will become molten and coat the desired areas of the steel middle structure layer 110. After cooled, the molten coat of glass and/or porcelain will form a layer on the middle structure layer 110. This layer is the writable and erasable layer 105.

After the middle structure layer 110 is allowed to cool, an optional cover coat spray of glass and/or porcelain particles can be applied to the steel middle structure layer 110 to add additional thickness to the writable and erasable layer 105. The cover coat can comprise one coating layer of frit, or several coating layers of frit. Again, oxides can be added with the glass and/or porcelain particles to add color. If a cover coat spray of glass and/or porcelain particles is applied to the steel middle structure layer 110, the middle structure layer 110 is then fired again between about 600 and about 900° C. The middle structure layer 110 and is then allowed to cool to room temperature, at which point the molten ground layer and optional cover coat spray will solidify and become the writable and erasable layer 105. This process will produce an upper di-layered sheet 165 having a steel middle structure layer 110 and a glass and/or porcelain writable and erasable layer 105.

Additionally, in an embodiment of a replacement skin for a writing surface, a lower di-layered sheet 160 comprising a peel-off protective back cover 120 connected to connective layer 115 can be produced by conventional means well known in the art. The connective layer 115 is preferably evenly dispersed on the peel-off protective back cover 120.

The lower di-layered sheet 160 comprising a connective layer 115 and a peel-off protective back cover 120, and the upper di-layered sheet 165 comprising a writable and erasable layer 105 and a middle structure layer 110 can be substantially connected together by a connecting process. A non-limiting example of a connecting process is a lamination process. Non-limiting examples of lamination processes include flame lamination, hot roll lamination, cold lamination, belt lamination, calender lamination, and sheet extrusion.

In an embodiment of the present invention, the lower di-layered sheet 160 is laminated onto the upper di-layered sheet 165 by heating the lower di-layered sheet 160, and then press fitting the lower di-layered sheet 160 onto the upper di-layered sheet 165. The lower di-layered sheet 160 can be heated by at least one roller 170 of the lamination apparatus. The strength of the bond between the upper and lower di-layered sheets, 165 and 160 respectively, can be controlled by the tension applied to both sheets by rollers 170 of a lamination apparatus. In an embodiment of the present invention, the AGL 64T laminator by Advanced Greig Laminators, Inc. can be used as a lamination apparatus. In an embodiment of the present invention, the lamination process connects the lower di-layered sheet 165 to the upper di-layered sheet 160 such that the bond between the upper and lower di-layered sheets, 165 and 160 respectively, is greater than the bond between the connective layer 115 and the peel-off protect back cover 120 of the lower di-layered sheet 160. As a non-limiting example, the bond between the middle structure layer 110 and the connective layer 115 is greater than the bond between the connective layer 115 and the peel-off protective back cover 120.

In another embodiment of the present invention, a lower di-layered sheet 160 is laminated onto an upper tri-layered sheet 155 by heating the lower di-layered sheet 160, and then press fitting the lower di-layered sheet 160 onto the upper tri-layered sheet 155. The lower di-layered sheet 160 can be heated by at least on roller 170 of the lamination apparatus. The strength of the bond between the upper di-layered sheet 160 and lower tri-layered sheet 155 can be controlled by the tension applied to both sheets by rollers 170 of a lamination apparatus, as previously mentioned above. In this particular embodiment, the bond between the core layer 125 and the connective layer 115 is greater than the bond between the connective layer 115 and the peel-off protective back cover 120.

The lamination process of the present subject matter increases the integrity of the bond between the lower di-layered sheet 160 and the upper tri-layered sheet 155 or the upper di-layered sheet 165. As a non-limiting example, the lamination process of the present invention produces a lower di-layered sheet 160 to be laminated to an upper di-layered sheet 155 such that the bond between the connective layer 115 and the middle structure layer 110 is greater than the bond between the connective layer 115 and the peel-off protective back cover. The bond integrity between the lower di-layered sheet 160 and the upper tri-layered sheet 155 or upper di-layered sheet 165 is an important aspect of the present invention. The bond integrity is an important aspect of the present invention, since when the replacement skin for a writing surface 100 resulting from the above described process is installed, the peel-off protective back cover 120 is removed, and the connective layer 115 is fitted against an old writing surface of a chalk board or dry erase board.

The lamination process of the present subject matter additionally reduces undesirable effects between the lower di-layered sheet 160 and the upper tri-layered sheet 155 or the upper di-layered sheet 165, which can cause undesirable pre-delamination. Such undesirable effects include but are not limited to excessive bubbling, weakened bond strength, and warping between the connective layer 115 and the core layer 125 or middle structure layer 110.

The below illustrative examples are exemplary embodiments of the present inventive subject matter, and in no way should be construed as limiting the scope and breadth of the current disclosure.

### EXAMPLE 1

Replacement skin 100 comprises a writable and erasable layer 105 constructed from porcelain, which is fused to middle structure layer 110 constructed from steel. Writable and erasable layer 105 and structure layer 110 are substantially the same size in two dimensions and are connected to core layer 125, which is constructed from fiber board. Connective layer 115 comprises an acrylic containing adhesive, and is between core layer 125 and peel-off protective back cover 120, wherein the peel-off protective back cover 120 is constructed from a flexible polymeric material. The writable and erasable layer 105, middle structure layer 110, core layer 125, connective layer 115, and peel-off protective back cover 120 are all substantially the same size in two dimensions and form a layered sheet.

### EXAMPLE 2

In another embodiment of a replacement skin 100 for a writing surface, the replacement skin 100 comprises a writable and erasable layer 105 constructed from porcelain, which is fused to middle structure layer 110 constructed from steel. Writable and erasable layer 105 and structure layer 110 are substantially the same size in two dimensions. Connective layer 115 comprises an acrylic containing adhesive, and is between structure layer 110 and peel-off protective back cover 120, wherein the peel-off protective back cover 120 is constructed from a flexible polymeric material. The writable and erasable layer 105, middle structure layer 110, connective layer 115, and peel-off protective back cover 120 are all substantially the same size in two dimensions and form a layered sheet.

### EXAMPLE 3

In another embodiment of a replacement skin 100 for a writing surface, the replacement skin 100 comprises a writable and erasable layer 105 constructed from a polymer such as melamine, which is adhered to middle structure layer 110 constructed from a flexible polymeric material. Writable and erasable layer 105 and structure layer 110 are substantially the same size in two dimensions. Connective layer 115 comprises an acrylic containing adhesive, and is between structure layer 110 and peel-off protective back cover 120, wherein the peel-off protective back cover 120 is constructed from the same or different flexible polymeric material used in constructing the middle structure layer 110. The writable and erasable layer 105, middle structure layer 110, connective layer 115, and peel-off protective back cover 120 are all substantially the same size in two dimensions and form a layered sheet. Additionally, the above described embodiment is flexible, and can be rolled up during packaging and shipping.

### EXAMPLE 4

In another embodiment of a replacement skin 100 for a writing surface, the replacement skin 100 comprises a writable and erasable layer 105 constructed from slate, which is fused or adhered to middle structure layer 110 constructed from steel. Writable and erasable layer 105 and structure layer 110 are substantially the same size in two dimensions. Connective layer 115 comprises an acrylic containing adhesive, and is between structure layer 110 and peel-off protective back cover 120, wherein the peel-off protective back cover 120 is constructed from a flexible polymeric material. The writable and erasable layer 105, middle structure layer 110, connective layer 115, and peel-off protective back cover 120 are all substantially the same size in two dimensions and form a layered sheet.

### EXAMPLE 5

A failing dry erase board surface needs to be refurbished due to undesirable conditions of the board, which can include for example loss of luster, ghosting, chipping, and cracking. The old writing surface of the dry erase board is thoroughly cleaned using a cleaner comprising either a soap solution, alcohol solution, or similar cleaning solution. The old writing surface of the dry erase board is then dried such that no residue remains on the old writing surface. A replacement skin 100 having at least a writable and erasable layer 105 constructed from porcelain or melamine, a connective layer 115 constructed from an acrylic containing adhesive, and a peel-off protective back cover 120 constructed from a polymeric material is fitted over the old writing surface of the dry erase board. Once the board is properly fitted, the peel-off protective back cover 120 is removed from the replacement skin 100 exposing the connective layer 115. The replacement skin 100 with exposed connective layer 115 is then attached to the old writing surface of the dry erase board to substantially cover the old writing surface. Pressure is applied across the surface of the replacement skin 100 to ensure the connective layer 11 5 attaches to the old writing surface of the dry erase board.

### EXAMPLE 6

A failing chalk board surface needs to be refurbished and converted into a dry erase board due to undesirable conditions of the board, which can include for example loss of luster, ghosting, chipping, and cracking. The old writing surface of the chalk board is thoroughly cleaned using a cleaner comprising either a soap solution, alcohol solution, or similar cleaning solution. The old writing surface of the chalk board is then dried such that no residue remains on the old writing surface. A replacement skin 100 having at least a writable and erasable layer 105 constructed from porcelain or melamine, a connective layer 115 constructed from an acrylic adhesive, and a peel-off protective back cover 120 constructed from a polymeric material is fitted over the old writing surface of the chalk board. Once the board is properly fitted, the peel-off protective back cover 120 is removed from the replacement skin 100 exposing the connective layer 115. The replacement skin 100 with exposed connective layer 115 is then attached to the old writing surface of the chalk board to substantially cover the old writing surface. Pressure is applied across the surface of the replacement skin 100 to ensure the connective layer 115 attaches to the old writing surface of the chalk board.

### EXAMPLE 7

A failing chalk board surface needs to be refurbished due to undesirable conditions of the board, which can include for example loss of luster, chipping, and cracking. The old writing surface of the chalk board is thoroughly cleaned using a cleaner comprising either a soap solution, alcohol solution, or similar cleaning solution. The old writing surface of the chalk board is then dried such that no residue remains on the old writing surface. A replacement skin 100 having at least a writable and erasable layer 105 constructed from slate, a connective layer 115 constructed from an acrylic adhesive, and a peel-off protective back cover 120 constructed from a polymeric material is fitted over the old writing surface of the chalk board. Once the board is properly fitted, the peel-off protective back cover 120 is removed from the replacement skin 100 exposing the connective layer 115. The replacement skin 100 with exposed connective layer 115 is then attached to the old writing surface of the chalk board to substantially cover the old writing surface. Pressure is applied across the surface of the replacement skin 100 to ensure the connective layer 115 attaches to the old writing surface of the chalk board.

### EXAMPLE 8

A middle structure layer 110 constructed from steel is placed in a degreaser bath and allowed to soak to remove impurities from the surface of the steel. The middle structure layer 110 is then placed in an acid bath to etch the surface. The middle structure layer 110 is then removed from the acid bath and rinsed and neutralized. A ground coat of frit is applied to the middle structure layer 110 and fired at about 830° C. When the frit becomes molten and forms a layer on the middle structure layer 110, the middle structure layer 110 is removed and allowed to cool to room temperature forming an upper di-layered sheet. A lower di-layered sheet comprising a connective layer 115 and a peel-off protective back cover 120 is prepared and fed into a AGL 64T laminator by Advanced Greig Laminators, Inc. The upper di-layered sheet is fed into the AGL 64T laminator and the lower di-layered sheet is press fitted and laminated onto the upper di-layered sheet. The bond between the middle structure layer 110 of the upper di-layered sheet and the connective layer 115 of the lower di-layered sheet is greater than the bond between the connective layer 115 and the peel-off protective back cover 120 of the lower di-layered sheet.

### EXAMPLE 9

A lower di-layered sheet comprising a connective layer 115 and a peel-off protective back cover 120 is laminated onto an upper di-layered sheet comprising a writable and erasable layer 105, a middle structure layer 110, and a core layer 125. The bond between the core layer 125 of the upper di-layered sheet and the connective layer 115 of the lower di-layered sheet is greater than the bond between the connective layer 115 and the peel-off protective back cover 120 of the lower di-layered sheet.

The present inventive subject matter has been described with respect to selected embodiments. However, other embodiments would be obvious to those skilled in the art without departing from the spirit and scope of the appended claims.

I claim:

1) A replacement skin for a writing surface comprising:
a top writable and erasable layer;
a middle structure layer fused to said top writable and erasable layer;
a connective layer laminated to said middle structure layer; and
a peel-off protective back cover connected to said connective layer.

2) The replacement skin of claim 1, wherein said connective layer is substantially connected to said middle structure layer.

3) The replacement skin of claim 1, wherein said connective layer and said middle structure layer are laminated together such that a bond between said back connective layer and said middle structure layer is greater than a bond between said connective layer and said peel-off protective back cover.

4) The replacement skin of claim 1, wherein said peel-off protective back cover comprises a material selected from the group consisting of polymer and cellulose containing material.

5) The replacement skin of claim 4, wherein said material is selected from at least one polymer of the group consisting of crystalline polymer, amorphous polymer, semi-crystalline polymer, thermoset polymer, thermoplastic polymer, elastomer polymer, and combinations thereof.

6) The replacement skin of claim 4, wherein said peel-off protective back cover comprises at least one polymer selected from the group consisting of paraffin wax, polypropylene, polyethylene, polyurethane, polybutylene, polysulfone, polyethersulfone, high-molecular-weight polyethersulfone, polyphenylsulfone, polyvinylidene, fluoride polyamide-imide, PVDF homopolymer, PVDF copolymer, PVDF homopolymer, ECTFE copolymer, ECTFE nBuA terpolymer, polyarylamide, liquid crystal polymer, acrylonitrile-butadiene-styrene, allyl resin, aramid, bakelit, diene polymer, dimethylformamid, epoxy, polyvinyl chloride, hydroxy-terminated polybutadiene (HTPB), teflon, nylon 6, nylon 6,6, polycarbonate, polyester, silicones, nylon, PA (Polyamid), PE (Polyethylen), phenol-formaldehyde, polyacrylates, polyacrylonitrile, polybutadiene, polyetherimide, polygermane, polystannane, polyimide, polyisoprene, polymethyl methacrylate, polyoxymethylene, polyoxymethylene copolymer, polyoxymethylene homopolymer, poly(para-xylylene), poly(phenylene oxide), poly(phenylenesulfide), polyphosphazenes, polypropylen, polysilanes, polystyrene, polystyrol, polytetrafluoroethylen, polyurethan, synthetic polyisoprene, and vinyl.

7) The replacement skin of claim 4, wherein said material comprises at least one cellulose containing material selected from the group consisting of paper, wax paper, asphalt paper, kraft liner, abrasive kraft, absorbent kraft, wet strength paper, parchment paper, gray chip, schrenz, testliner, volatile corrosion inhibitor paper, alkaline paper, anti-rust paper, antique paper, azurelaid paper, and base paper.

8) The replacement skin of claim 1, further comprising a core layer connected to at least one other layer selected from the group consisting of said top writable and erasable layer, said middle structure layer, and said connective layer.

9) The replacement skin of claim 8, wherein said core layer comprises at least one material selected from the group consisting of a metal, an alloy, an elastomer, a polymer, a plastic, a wood, fiberboard, particleboard, corkboard, steel, glass, and combinations thereof.

10) The replacement skin of claim 1, wherein said top writable and erasable layer comprises at least one element selected from the group consisting of glass, porcelain, slate, rubber, melamine, iron, and steel.

11) The replacement skin of claim 1, wherein said top writable and erasable layer comprises at least one polymer.

12) The replacement skin of claim 1, wherein said middle structure layer comprises at least one material selected from the group consisting of a metal, an alloy, an elastomer, a polymer, a wood, a glass, porcelain, slate, rubber, melamine, iron, steel, and combinations thereof.

13) The replacement skin of claim 1, wherein said connective layer comprises at least one adhesive selected from the group consisting of adhesive dispersion, solids adhesive, solvent-borne adhesive, heat-activated adhesive, reactive adhesive, contact adhesive, hot-melt adhesive, spray adhesive, liquid adhesive, emulsion adhesive, rubber containing adhesive, acrylic containing adhesive, modified acrylic containing adhesive, polyurethane containing adhesive, polyvinyl acetate containing adhesive, polychloroprene containing adhesive, isocyanate containing adhesive, polyisocyanate containing adhesive, polyol containing adhesive, butyl rubber containing adhesive, ethylene vinyl acetate containing adhesive, silicone containing adhesive, organosiloxane containing adhesive, methacrylic containing adhesive, epoxy containing adhesive, rubber containing adhesive, and cyanoacrylate containing adhesive.

14) A replacement skin for a writing surface comprising:
a top writable and erasable layer comprising porcelain;
a middle structure layer fused to said top writable and erasable layer comprising steel; and
a connective layer comprising an acrylic adhesive laminated to said middle structure layer.

15) The replacement skin of claim 14, further comprising a core layer interposed between said middle structure layer and said connective layer, said core layer selected from the group consisting of fiberboard, particleboard, corkboard, and combinations thereof.

16) A method of refurbishing a writing surface comprising
cleaning an old writing surface of a writing board;
applying alcohol to the old writing surface of the writing board;
removing a peel-off protective back cover from said replacement skin of claim 1;
attaching said replacement skin of claim 1 to said old writing surface;
applying pressure to said replacement skin to adhere said connective layer of claim 1 to said old writing surface.

17) A method of refurbishing a writing surface of claim 19, wherein said alcohol is in a solution comprising water.

18) A method of manufacturing a replacement skin for a writing surface comprising:
fusing a top writable and erasable layer to a middle structure layer to produce an upper di-layered sheet,
connecting a connective layer to a peel-off protective back cover to produce a lower di-layered sheet, and
laminating said lower di-layered sheet to said upper di-layered sheet.

19) A method of manufacturing a replacement skin for a writing surface of claim 18, wherein said upper di-layered sheet further comprises a core layer to produce an upper tri-layered sheet.

20) A method of manufacturing a replacement skin for a writing surface of claim 18, further comprising heating said lower di-layered sheet.
